(19) United States
(12) Patent Application Publication
(10) Pub. No.: US 2023/0334710 A1
(43) Pub. Date: Oct. 19, 2023

(54) SUPPORT OF VISUAL VOLUMETRIC VIDEO-BASED CODING (V3C) IN IMMERSIVE SCENE DESCRIPTION

(71) Applicant: Samsung Electronics Co., Ltd., Suwon-si (KR)

(72) Inventor: Youngkwon Lim, Allen, TX (US)

(21) Appl. No.: 18/299,667

(22) Filed: Apr. 12, 2023

Related U.S. Application Data
(60) Provisional application No. 63/332,568, filed on Apr. 19, 2022.

(51) Int. Cl. G06T 9/00; G06T 15/08

(52) U.S. Cl. CPC G06T 9/00; G06T 15/08; G06T 2210/56

(57) ABSTRACT

An apparatus includes a communication interface and a processor operably coupled to the communication interface. The communication interface includes a buffer. The processor is configured to receive, via the communication interface, a scene description for visual volumetric video-based coding (V3C) content, wherein the scene description indicates a media stream for a V3C atlas and media streams for V3C components. The processor is also configured to receive, via the communication interface, a plurality of media streams of the V3C content. The processor is further configured to render the plurality of media streams based on the scene description for the V3C content.

### CROSS-REFERENCE TO RELATED APPLICATION AND PRIORITY CLAIM

This application claims priority under 35 U.S.C. § 119(e) to U.S. Provisional Patent Application No. 63/332,568 filed on Apr. 19, 2022, which is hereby incorporated by reference in its entirety.

### TECHNICAL FIELD

This disclosure relates generally to multimedia devices and processes. More specifically, this disclosure relates to support of visual volumetric video-based coding (V3C) in immersive scene description.

### BACKGROUND

ISO/TEC 23090-14 Scene Description for MPEG Media indicates that a graphics language transmission format (g1TF) JavaScript object notation (JSON) documents are marked as sync samples and potential usage of redundant samples for random access, but it does not provide detailed descriptions on mechanisms to list all the V3C components while indicating that they are not independently playable and mechanisms to indicate grouping of V3C atlas tracks and V3C component tracks comprising a single V3C content and/or referencing from the V3C atlas tracks to the V3C component tracks.

### SUMMARY

This disclosure provides devices and methods for support of visual volumetric video-based coding (V3C) in immersive scene description.

In a first embodiment, an apparatus includes a communication interface and a processor operably coupled to the communication interface. The communication interface includes a buffer. The processor is configured to receive, via the communication interface, a scene description for visual volumetric video-based coding (V3C) content, wherein the scene description indicates a media stream for a V3C atlas and media streams for V3C components. The processor is also configured to receive, via the communication interface, a plurality of media streams of the V3C content. The processor is further configured to render the plurality of media streams based on the scene description for the V3C content.

In a second embodiment, a method includes receiving a scene description for V3C content, wherein the scene description indicates a media stream for a V3C atlas and media streams for V3C components. The method also includes receiving a plurality of media streams of the V3C content. The method further includes rendering the plurality of media streams based on the scene description for the V3C content.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIG. 4A illustrates a block diagram of an example environment-architecture in accordance with an embodiment of this disclosure;

FIG. 4B illustrates an example block diagram of an encoder in accordance with an embodiment of this disclosure;

FIG. 4C illustrates an example block diagram of a decoder in accordance with an embodiment of this disclosure;

FIGS. 5A and 5B illustrate example scene description reference architectures in accordance with this disclosure; and

FIG. 6 illustrates an example method for support of V3C in an immersive scene description according to this disclosure.

### DETAILED DESCRIPTION

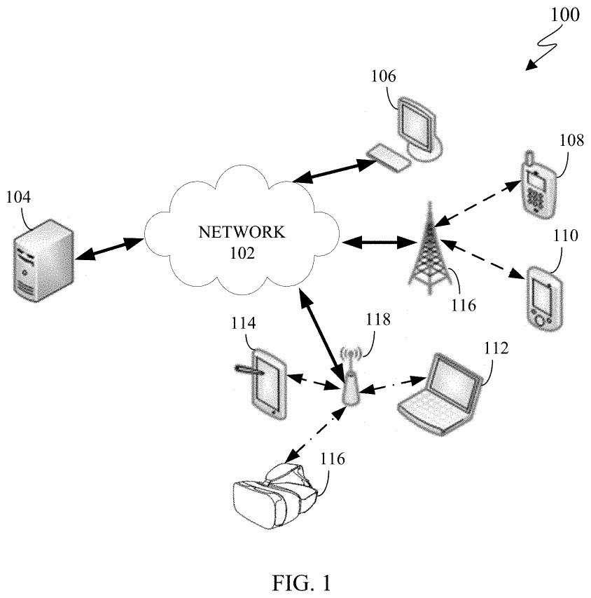

FIGS. 1 through 6, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

The format of data delivered through the buffers were not clearly specified. As the decoding is performed by the pipelines in MAF and 3D reconstruction is performed by the presentation engine by using appropriate V3C shaders, raw data decoded by the Pipelines should be delivered to the Presentation Engine through the Buffers. Decoded raw data by the pipelines corresponds to the conformance point A defined by ISO/IEC 23090-5 and reconstructed 3D point clouds corresponds to the conformance point B defined by ISO/IEC 23090-5. In addition, an output format of the decoded raw data to delivered by the buffers are normally defined by ISO/IEC 23090-5. One restriction applied to the decoded data format defined by conformance point A of ISO/IEC 23090-5 is that each buffer delivers decoded data from a single video decoder. Actual syntax and semantics of the data format need to be specified by each V3C shader through APIs of the MAF.

Storage and delivery of V3C content considers each individual V3C atlas bitstream and V3C component bitstreams as individual bitstream, and mechanisms for grouping and referencing are provided to indicate how a V3C content is composed. The scene description for V3C content must follow this principle so that the integrity of the technologies in MPEG-I project can be preserved and technologies already defined by the specifications can be reused with minimal extensions.

ISO/IEC 23090-14 has introduced the MPEG_media extension to reference external media stored in ISOBMFF files or can be fetched through DASH MPD. In addition, the MPEG_media extension has been defined that the V3C atlas track is referenced by MPEG_media when V3C content is included, which is aligned with the design principle of ISO/IEC 23090-10, using the V3C atlas track as entry point.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

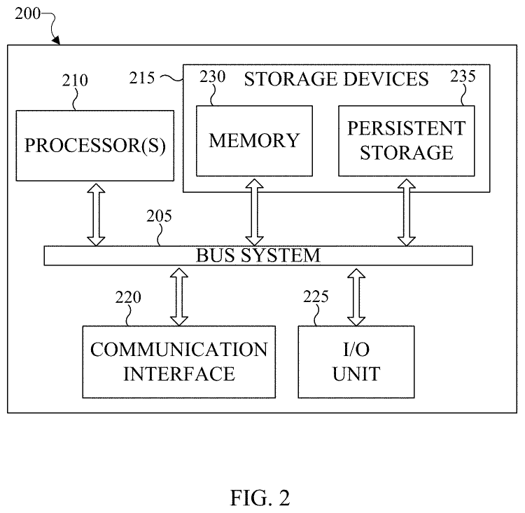

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

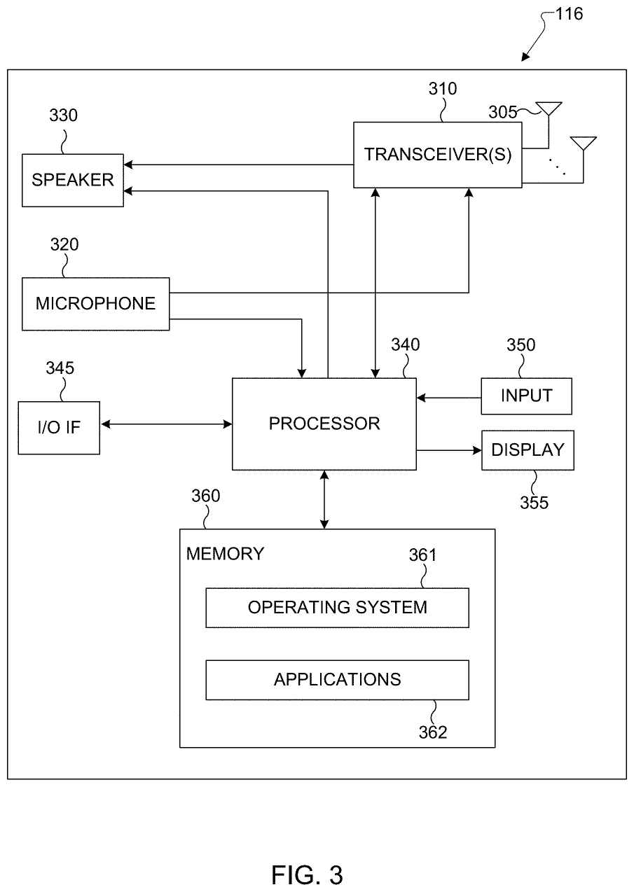

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

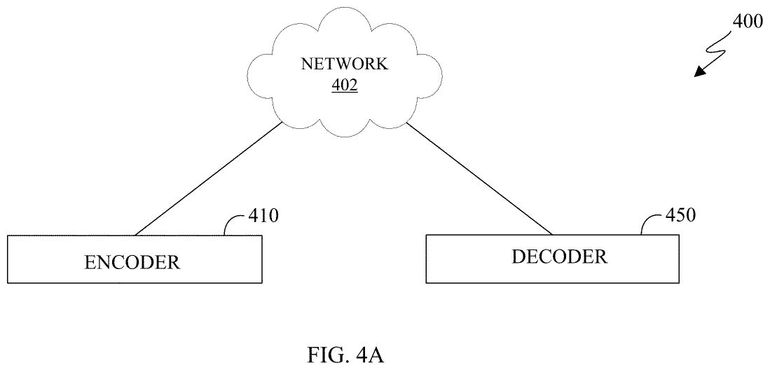

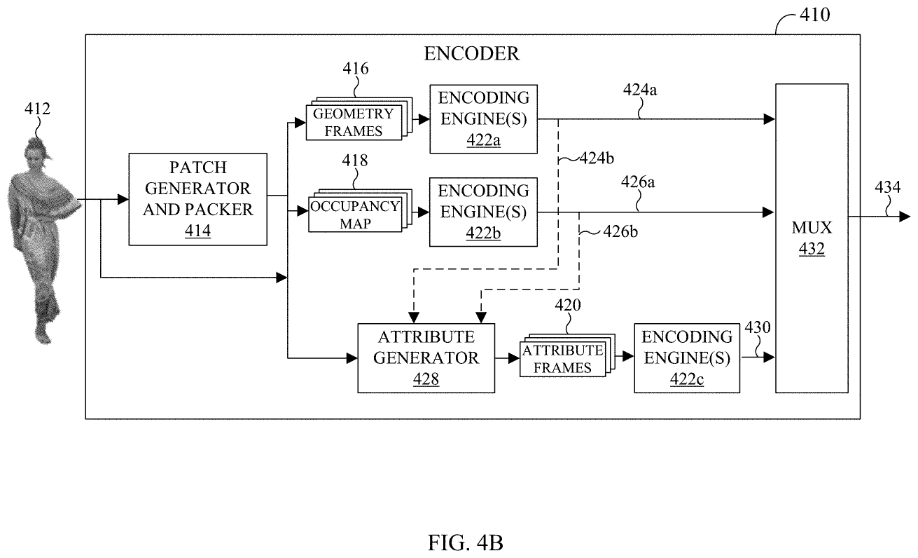

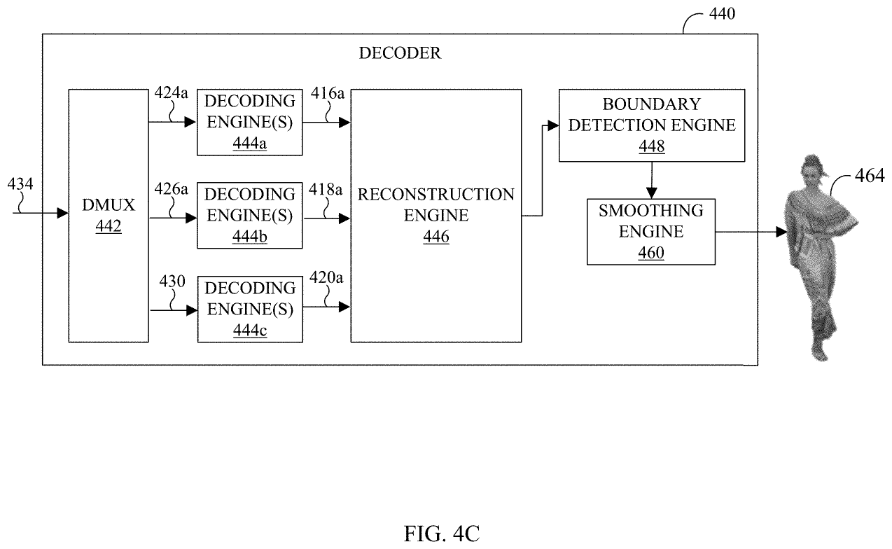

FIGS. 4A, 4B, and 4C illustrate block diagrams in accordance with an embodiment of this disclosure. In particular, FIG. 4A illustrates a block diagram of an example environment-architecture 400 in accordance with an embodiment of this disclosure. FIG. 4B illustrates an example block diagram of the encoder 410 of FIG. 4A and FIG. 4C illustrates an example block diagram of the decoder 450 of FIG. 4A in accordance with an embodiment of this disclosure. The embodiments of FIGS. 4A, 4B, and 4C are for illustration only. Other embodiments can be used without departing from the scope of this disclosure.

As shown in FIG. 4A, the example environment-architecture 400 includes an encoder 410 and a decoder 450 in communication over a network 402. The network 402 can be the same as or similar to the network 102 of FIG. 1. In certain embodiments, the network 402 represents a “cloud” of computers interconnected by one or more networks, where the network is a computing system utilizing clustered computers and components that act as a single pool of seamless resources when accessed. Also, in certain embodiments, the network 402 is connected with one or more servers (such as the server 104 of FIG. 1, the server 200), one or more electronic devices (such as the client devices 106-116 of FIG. 1, the electronic device 300), the encoder 410, and the decoder 450. Further, in certain embodiments, the network 402 can be connected to an information repository (not shown) that contains a VR and AR media content that can be encoded by the encoder 410, decoded by the decoder 450, or rendered and displayed on an electronic device.

In certain embodiments, the encoder 410 and the decoder 450 can represent the server 104, one of the client devices 106-116 of FIG. 1, the server 200 of FIG. 2, the electronic device 300 of FIG. 3, or another suitable device. In certain embodiments, the encoder 410 and the decoder 450 can be a “cloud” of computers interconnected by one or more networks, where each is a computing system utilizing clustered computers and components to act as a single pool of seamless resources when accessed through the network 402. In some embodiments, a portion of the components included in the encoder 410 or the decoder 450 can be included in different devices, such as multiple servers 104 or 200, multiple client devices 106-116, or other combination of different devices. In certain embodiments, the encoder 410 is operably connected to an electronic device or a server while the decoder 450 is operably connected to an electronic device. In certain embodiments, the encoder 410 and the decoder 450 are the same device or operably connected to the same device.

The encoder 410 is described with more below in FIG. 4B. Generally, the encoder 410 receives 3D media content, such as a point cloud, from another device such as a server (similar to the server 104 of FIG. 1, the server 200 of FIG. 2) or an information repository (such as a database), or one of the client devices 106-116. In certain embodiments, the encoder 410 can receive media content from multiple cameras and stitch the content together to generate a 3D scene that includes one or more point clouds.

The encoder 410 projects points of the point cloud into multiple patches that represent the projection. The encoder 410 clusters points of a point cloud into groups which are projected onto different planes such as an XY plane, an YZ plane, and an XZ plane. Each cluster of points is represented by a patch when projected onto a plane. The encoder 410 packs and stores information representing the onto a 2D frame. The encoder 410 packs the patches representing the point cloud onto 2D frames. The 2D frames can be video frames. It is noted, a point of the 3D point cloud is located in 3D space based on a (X, Y, Z) coordinate value, but when the point is projected onto a 2D frame the pixel representing the projected point is denoted by the column and row index of the frame indicated by the coordinate (u, v). Additionally, ‘u’ and ‘v’ can range from zero to the number of rows or columns in the depth image, respectively.

Each of the 2D frames represents a particular attribute, such as one set of frames can represent geometry and another set of frames can represent an attribute (such as color). It should be noted that additional frames can be generated based on more layers as well as each additionally defined attribute.

The encoder 410 also generates an occupancy map based on the geometry frame and the attribute frame(s) to indicate which pixels within the frames are valid. Generally, the occupancy map indicates, for each pixel within a frame, whether the pixel is a valid pixel or an invalid pixel. For example, if a pixel in the occupancy map at coordinate (u, v) is valid, then the corresponding pixel in a geometry frame and the corresponding attribute frame at the coordinate (u, v) are also valid. If the pixel in the occupancy map at coordinate (u, v) is invalid, then the decoder skips the corresponding pixel in the geometry and attribute frames at the coordinate (u, v). An invalid pixel can include information such as padding that can increase the encoding efficiency but does not provide any information associated with the point cloud itself. Generally, the occupancy map is binary, such that the value of each pixel is either one or zero. For example, when the value of a pixel at position (u, v) of the occupancy map is one, indicates that a pixel at (u, v) of an attribute frame and the geometry frame is valid. In contrast, when the value of a pixel at position (u, v) of the occupancy map is zero indicates that a pixel at (u, v) of the attribute frame and the geometry frame is invalid, and therefore does not represent a point of the 3D point cloud.

The encoder 410 transmits frames representing the point cloud as an encoded bitstream. The bitstream can be transmitted to an information repository (such as a database) or an electronic device that includes a decoder (such as the decoder 450), or the decoder 450 itself through the network 402. The encoder 410 is described in greater detail below in FIG. 4B.

The decoder 450, which is described with more below in FIG. 4C, receives a bitstream that represents media content, such as a point cloud. The bitstreams can include data representing a 3D point cloud. In certain embodiments, the decoder 450 can decode the bitstream and generate multiple frames such as one or more geometry frames, one or more attribute frames, and one or more occupancy map frames. The decoder 450 reconstructs the point cloud using the multiple frames, which can be rendered and viewed by a user The decoder 450 can identify points on the reconstructed 3D point cloud that were represented on or near a boundary of one of the patches on one of the frames.

The decoder 450 can also perform smoothing, such as geometry smoothing. To perform smoothing the decoder 450 identifies boundary points of the reconstructed 3D point cloud and then identifies boundary cells associated with the boundary points. The decoder 450 derives a centroid value of the identified boundary cells. The centroid value is used to determine determines that smoothing is necessary. When the decoder 450 determines that smoothing is necessary for a particular boundary point, based on the centroid values of the cells associated with that particular boundary point, the decoder 450 uses those centroid values to smooth the boundary point.

FIG. 4B illustrates the encoder 410 that receives a 3D point cloud 412 and generates a bitstream 434. The bitstream 434 includes data representing a 3D point cloud 412. The bitstream 434 can include multiple bitstreams. The bitstream 434 can be transmitted via the network 402 of FIG. 4A to another device, such as the decoder 450, an electronic device that includes the decoder 450, or an information repository. The encoder 410 includes a patch generator and packer 414, one or more encoding engines (such as encoding engine 422a, 422b, and 422c, which are collectively referred to as encoding engines 422), an attribute generator 428, and a multiplexer 432.

The 3D point cloud 412 can be stored in memory (not shown) or received from another electronic device (not shown). The 3D point cloud 412 can be a single 3D object, or a grouping of 3D objects. The 3D point cloud 412 can be a stationary object or an object which moves.

The patch generator and packer 414 generates patches by taking projections of the 3D point cloud 412 and packs the patches into frames. In certain embodiments, the patch generator and packer 414 splits the geometry information and attribute information of each point of the 3D point cloud 412. The patch generator and packer 414 can use two or more projection planes, to cluster the points of the 3D point cloud 412 to generate the patches. The geometry patches are eventually packed into the geometry frames 416.

The patch generator and packer 414 determines the best projection plane for each point of the 3D point cloud 412. When projected, each cluster of points of the 3D point cloud 412 appears as patch (also referred to as a regular patch). A single cluster of points can be represented by multiple patches (located on different frames), where each patch represents a particular aspect of each point within the cluster of points. For example, a patch representing the geometry locations of the cluster of points is located on the geometry frame 416, and patch representing an attribute of the cluster of points is located on the attribute frame 420.

After determining the best projection plane for each point of the 3D point cloud 412 the patch generator and packer 414 segments the points into patch data structures that are packed frames, such as the geometry frames 416. It is noted that patches representing different attributes of the same cluster of points include a correspondence or a mapping, such a pixel in one patch corresponds to the same pixel in another patch, based on the locations of the pixels being at the same position in the respective frames.

The patch generator and packer 414 also generates patch information (providing information about the patches, such as an index number that is associated with each patch), occupancy map frames 418, geometry frames 416 and attribute information (which is used by the attribute generator 428 to generate the attribute frames 420).

The occupancy map frames 418 represent occupancy maps that indicate the valid pixels in the frames (such as the geometry frames 416). For example, the occupancy map frames 418 indicate whether each pixel in the geometry frame 416 is a valid pixel or an invalid pixel. Each valid pixel in the occupancy map frames 418 corresponds to pixels in the geometry frames 416 that represents a position point of the 3D point cloud 412 in 3D space. In contrast, the invalid pixels are pixels within the occupancy map frames 418 correspond to pixels in the geometry frames 416 that do not represent a point of the 3D point cloud 412. In certain embodiments, one of the occupancy map frames 418 can correspond to both a geometry frame 416 and an attribute frame 420 (discussed below).

For example, when the patch generator and packer 414 generates the occupancy map frames 418, the occupancy map frames 418 include predefined values for each pixel, such as zero or one. For example, when a pixel of the occupancy map at position (u, v) is a value of zero, indicates that the pixel at (u, v) in the geometry frame 416 is invalid. Similarly, when a pixel of the occupancy map at position (u, v) is a value of one, indicates that the pixel at (u, v) in the geometry frame 416 is valid and thereby includes information representing a point of the 3D point cloud.

The geometry frames 416 include pixels representing the geometry values of the 3D point cloud 412. The geometry frames 416 include the geographic location of each point of the 3D point cloud 412. The geometry frames 416 are used to encode the geometry information of the point cloud. For example, the two transverse coordinates (with respect to the projection plane) of a 3D point corresponds to the column and row indices in the geometry video frame (u, v) plus a transverse-offset which indicates the location of the entire patch within the video frame. The depth of the 3D point is encoded as the value of the pixel in the video frame plus a depth-offset for the patch. The depth of the 3D point cloud depends on whether the projection of the 3D point cloud is taken from the XY, YZ, or XZ coordinates.

The encoder 410 includes one or more encoding engines 422. In certain embodiments, the frames (such as the geometry frames 416, the occupancy map frames 418, and the attribute frames 420) are encoded by independent encoding engines 422, as illustrated. In other embodiments, a single encoding engine performs the encoding of the frames. In other embodiments,

[symbol]

The encoding engines 422 can be configured to support an 8-bit, a 10-bit, a 12-bit, a 14-bit, or a 16-bit, precision of data. The encoding engines 422 can include a video or image codec such as HEVC, AVC, VP9, VP8, VVC, EVC, AV1 and the like to compress the 2D frames representing the 3D point cloud. The one or more of the encoding engines 422 can compress the information in a lossy or lossless manner.

As illustrated, the encoding engine 422a receives geometry frames 416 performs geometry compression to generate a geometry sub-stream 424a. The encoding engine 422b receives occupancy map frames 418 performs occupancy map compression to generate an occupancy map sub-stream 426a. The encoding engine 422c receives attribute frames 420 performs attribute compression to generate an attribute sub-stream 430.

After the encoding engine 422a generates the geometry sub-stream 424a, a decoding engine (not shown) can decode the geometry sub-stream 424a to generate the reconstructed geometry frames 424b. Similarly, after the encoding engine 422b generates the occupancy map sub-stream 4246, a decoding engine (not shown) can decode the occupancy map sub-stream 426a to generate the reconstructed occupancy map frames 426b.

The attribute generator 428 generates the attribute frames 420 based on the attribute information from the 3D point cloud 412, the reconstructed geometry frames 424b, the reconstructed occupancy map frames 426b, and information provided by the patch generator and packer 414.

For example, to generate one of the attribute frames 420 that represent color, the geometry frames 416 are compressed by the encoding engine 422a using a 2D video codec such as HEVC. The geometry sub-stream 424a is decoded to generate the reconstructed geometry frames 424b. Similarly, the occupancy map frame 418 is compressed using the encoding engine 422b and then decompressed to generate the reconstructed occupancy map frames 426b. The encoder 410 can then reconstruct the geometric locations of the points of the 3D point cloud based on the reconstructed geometry frames 424b and the reconstructed occupancy map frames 426b. The attribute generator 428 interpolates the attribute values (such as color) of each point from the color values of input point cloud to the reconstructed point cloud and the original point cloud 412. The interpolated colors are then segmented, by the attribute generator 428, to match the same patches as the geometry information. The attribute generator 428 then packs interpolated attribute values into an attribute frame 420 representing color.

The attribute frames 420 represents different attributes of the point cloud. For example, for one of the geometry frames 416 there can be one or more corresponding attribute frames 420. The attribute frame can include color, texture, normal, material properties, reflection, motion, and the like. In certain embodiments, one of the attribute frames 420 can include color values for each of the geometry points within one of the geometry frames 416, while another attribute frame can include reflectance values which indicate the level of reflectance of each corresponding geometry point within the same geometry frame 416. Each additional attribute frame 420 represents other attributes associated with a particular geometry frame 416. In certain embodiments, each geometry frame 416 has at least one corresponding attribute frame 420.

The multiplexer 432 combines the patch sub-stream, the geometry sub-stream 424a, the occupancy map sub-stream 426a, and the attribute sub-stream 430, to create the bitstream 434.

FIG. 4C illustrates the decoder 450 that includes a demultiplexer 452, one or more decoding engines, a reconstruction engine 456, a boundary detection engine 458, and a smoothing engine 460.

The decoder 450 receives a bitstream 434, such as the bitstream that was generated by the encoder 410. The demultiplexer 452 separates bitstream 434 into one or more sub-streams representing the different information. For example, the demultiplexer 452 separates various streams of data such into the individual sub-streams such as the patch sub-stream, the geometry sub-stream 424a, the occupancy map sub-stream 426a, and the attribute sub-stream 436.

The decoder 450 includes one or more decoding engines. For example, the decoder 450 can include the decoding engine 454a, a decoding engine 454b, a decoding engine 454c, and a decoding engine 454d (collectively referred to as the decoding engines 454). In certain embodiments, a single decoding engine performs the operations of all of the induvial decoding engines 454.

The decoding engine 454a decodes the geometry sub-stream 424a into reconstructed geometry frames 416a. The reconstructed geometry frames 416a are similar to the geometry frames 416 of FIG. 4B, with the different being that one or more pixels may have shifted due to the encoding and decoding of the frames.

The decoding engine 454b decodes the occupancy map sub-stream 426a into reconstructed occupancy map frames 418a. The reconstructed occupancy map frames 418a are similar to the occupancy map frames 418 of FIG. 4B, with the different being that one or more pixels may have shifted due to the encoding and decoding of the frames.

The decoding engine 454c decodes the attribute map sub-stream 430 into reconstructed attribute frames 420a. The reconstructed attribute frames 420a are similar to the occupancy map frames 420 of FIG. 4B, with the different being that one or more pixels may have shifted due to the encoding and decoding of the frames.

After the patch information, the reconstructed geometry frames 416a, the reconstructed occupancy map frames 418a, and the reconstructed attribute frames 420a are decoded, the reconstruction engine 456 generates a reconstructed point cloud. The reconstruction engine 456 reconstructs the point cloud.

When the geometry frames 416, the occupancy map frames 418, and the attribute frames 420, are encoded by the encoding engines 422, and later decoded at the decoder 450, pixels from one patch can be inadvertently be switched with a pixel of another patch or an invalid pixel. As a result, visible artifacts can appear in the reconstructed point cloud, reducing the visual quality of the point cloud. For example, pixels within the reconstructed geometry frame 416a can shift slightly due to the encoding and decoding process. Generally when the pixel is in the middle of a patch, a slight shift may not significantly reduce the visual quality of the point cloud. However, a slight shifting or switching of a pixel off of a patch to a location that is indicated as empty (or invalid) by the occupancy map, can cause considerable artifacts, since a portion of the image would not be rendered. Similarly, a slight shifting or switching of a pixel from one patch to another patch can cause considerable artifacts.

In order to reduce the appearance of artifacts, points of the reconstructed 3D point cloud that are represented in the 2D frames as pixels which are near a boundary of a patch can be smoothed. To reduce the occurrence or appearance of a visual artifact and increase compression efficiency, the smoothing can be applied to the positions of the points of the point cloud, each identified attribute of the point cloud (such as color, reflectiveness, and the like), or both the geometry and the attributes of the point cloud.

In order to smooth the geometry, the attribute, or both the geometry and attribute of the 3D point cloud, the boundary detection engine 458 identifies the certain points of the 3D point cloud, denoted as boundary points. The boundary points of the 3D point cloud correspond to pixels of the reconstructed geometry frames 416a (or the reconstructed attribute frames 420) which are positioned at or near the boundary of each patch (based on the corresponding pixels in the reconstructed occupancy map frames 418a). The boundary detection engine 458 identifies the boundary points of the reconstructed point cloud, based on the values of the pixels within the reconstructed occupancy map frames 418a. For example, the boundary detection engine 458 identifies a boundary pixel within reconstructed occupancy map frames 418a.

To find a boundary pixel, the reconstructed occupancy map frames 418a inspects the values of the pixels in reconstructed occupancy map frames 418a to identify a valid pixel that is adjacent to an invalid pixel. For instance, the boundary detection engine 458 identifies a pixel with a value one, that is located adjacent to a pixel with a value of zero. An adjacent pixel can be one of the eight neighboring pixels (except if that pixel is located on the boundary of the occupancy map frame 418a).

To identify a boundary point of the point cloud, the boundary detection engine 458 inspects the pixels within the reconstructed occupancy map frames 418a. The boundary detection engine 458 inspects the reconstructed occupancy map frames 418a to identify a subset of pixels that are valid (based on the value) but are adjacent (neighbor) a pixel that is invalid (based on its value). For example, the boundary detection engine 458 inspects each pixel within the occupancy map frames 418. The inspection includes selecting a query pixel and identifying whether the query pixel is valid, based on the value of the query pixel. If the query pixel is invalid, the boundary detection engine 458 continues selecting new pixels within the occupancy map frames 418 until a valid query pixel is identified.

In certain embodiments, the boundary detection engine 458 identifies a boundary pixel based on a valid pixel being within a threshold distance from an invalid pixel. For example, the distance can include pixels within one-pixel distance from a query pixel, two-pixel distance from the query pixel, three-pixel distance from the query pixel, and the like. As the distance increases, the number of identified boundary points will also increase.

Upon identifying a boundary pixel, the boundary detection engine 458 identifies a corresponding pixel in the reconstructed geometry frame 416a that is positioned at the same location that the boundary pixel (of the occupancy map) is located. Thereafter, the boundary detection engine 458 identifies the point of the 3D point cloud that corresponds to the corresponding pixel in the reconstructed geometry frame 416a. That is, there is a correspondence between the identified boundary pixel of the reconstructed occupancy map frame 418a and a point in 3D space based on the correspondence between a pixel in the reconstructed occupancy map frame 418a and a pixel at the same location in the reconstructed geometry map frame 416a.

In addition to identifying the boundary points of the reconstructed point cloud the decoder 450 also splits the reconstructed point cloud into a 3D grid. The 3D grid includes multiple non-overlapping cells. The reconstructed point cloud is located within the 3D grid, such that the points of the 3D point cloud are located throughout the cells of the 3D grid. For example, the decoder 450 generates a 3D grid around the reconstructed point cloud 602. The shape and size of the cells can be uniform throughout the grid or change from cell to cell. FIG. 7B illustrates an example grid.

The decoder 450 then identifies specific cells of the grid that include the identified boundary points. That is, for each boundary point, the corresponding cell of the 3D grid is identified. The decoder also identifies certain neighboring cells that are adjacent to each of the cells that include the identified boundary points.

For example, for a query cell with a single boundary point and multiple other points, the decoder identifies seven other cells that are adjacent to the query cell. It is noted that a single cell has twenty six neighboring (adjacent) cells. The decoder 450 selects a predetermined number of the neighboring cells which are geometrically closest to the boundary point that is within the query cell. For example, the if the boundary point is in the lower left part of the cell, then the decoder 450 selects the neighboring cells that are located to the left and below the current cell. In certain embodiments, the predetermined number of cells that neighbor the cell with the query point is seven neighboring cells. The neighboring cells and the query cell, which includes the boundary point, are denoted as boundary cells. As such, in certain embodiments, there are a total of eight boundary cells (the seven neighboring cells and the query cell). In other embodiments, different number of cells can be identified as boundary cells.

The decoder 450 identifies the centroid for each of the boundary cells (the query cell that includes the boundary point and neighboring cells based on the position of the boundary point within the query cell), after selecting a predetermined number of boundary cells. The centroid of each boundary cell is based on the points included in each respective cells. The centroid for each of the boundary cells are stored in a look up table.

After the boundary points of the reconstructed point cloud are identified, the boundary cells are identified, and the centroid of the boundary cells are identified, the smoothing engine 460 determines whether to perform the smoothing with respect to each identified boundary point.

After the reconstruction engine 456 reconstructs the point cloud and the smoothing engine 460 determines whether to perform geometry smoothing, (and based on a determination to perform the smoothing to remove artifacts that were inadvertently created while the frames were encoded and decoded), the decoder 450 renders the reconstructed point cloud 464. The reconstructed point cloud 468 is rendered and displayed on a display or a head mounted display, similar to the HMD 116 of FIG. 1. The reconstructed point cloud 468 is similar to the 3D point cloud 412.

Although FIG. 4A illustrate the environment-architecture 400, FIG. 4B illustrates the encoder 410, and FIG. 4C illustrates the decoder 450, various changes can be made to FIGS. 4A, 4B, and 4C. For example, any number of encoders or decoders can be included environment-architecture 400.

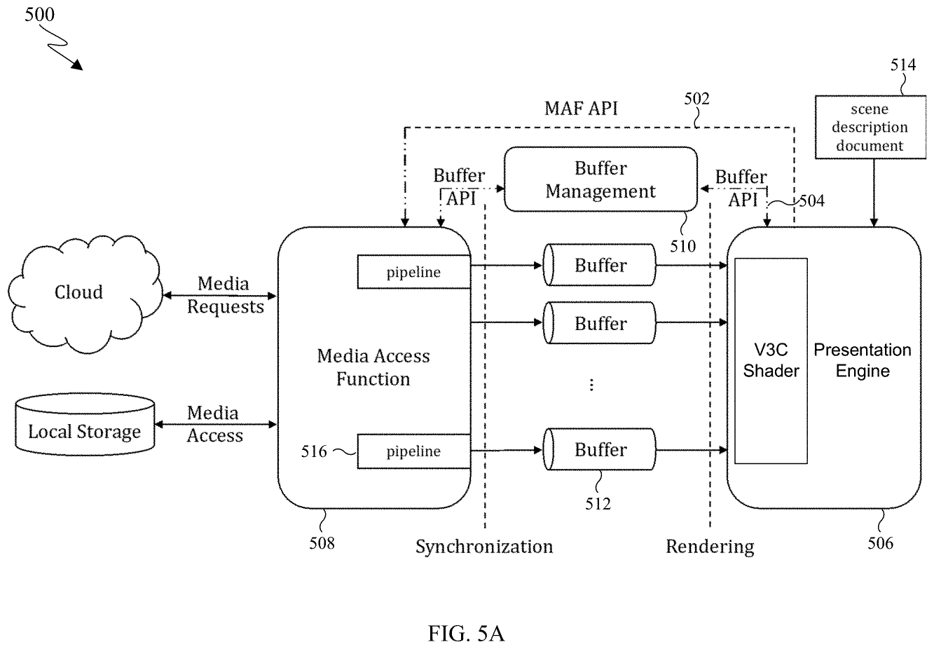

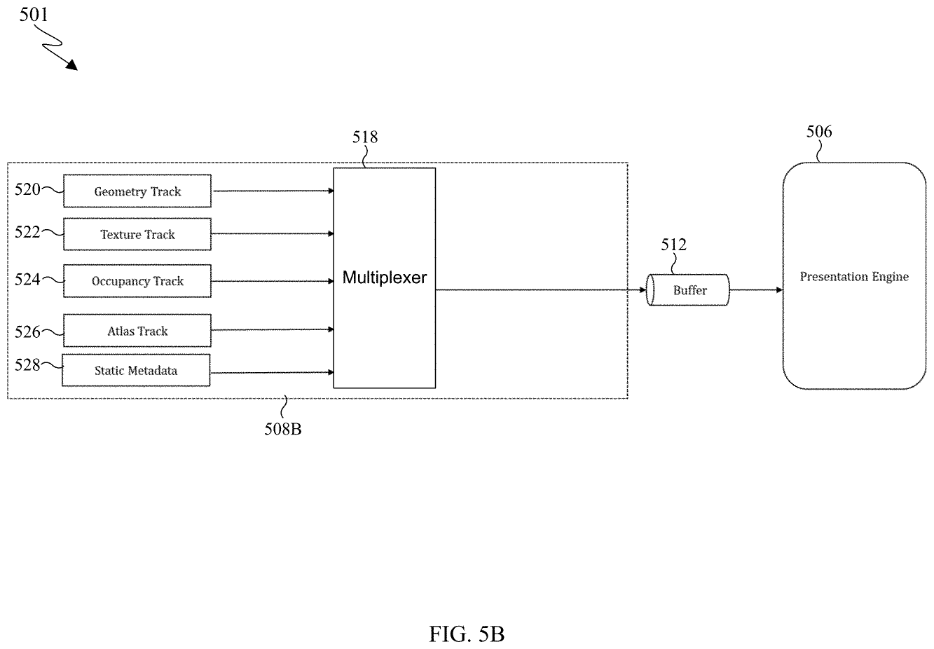

FIGS. 5A and 5B illustrate example scene description reference architectures 500 and 501 in accordance with this disclosure. The embodiment of the scene description reference architectures 500 and 501 illustrated in FIGS. 5A and 5B are for illustration only. FIGS. 5A and 5B does not limit the scope of this disclosure to any particular implementation of a scene description reference architecture.

Decoding of V3C bitstreams and reconstruction of volumetric contents are two individual steps, and the decoding is a normatively defined process and reconstruction is not. Therefore, scene description architecture must reflect such architectural design principle when V3C content is processed.

As shown in FIG. 5A, the scene description reference architecture 500 can include one or more interfaces, including a media application function (MAF) application programming interface (API) 502 and a buffer API 504, and one or more components, including a presentation engine 506, an MAF 508, a buffer manager 510, and buffers 512.

The MAF API 502 can be a standardized API that is offered by any compliant MAF 508 to the presentation engine 506. The buffer API 504 is used by the presentation engine 506 and the MAF 508 to control the buffer manager 510 to allocate and control buffers 512 for exchange of data between the presentation engine 506 and the MAF 508. The presentation engine 506 can render and process content of a scene. The MAF 508 is a function that retrieves and prepares media for rendering on request by the presentation engine 506.

The scene description document 514 is consumed by a presentation engine 506 to render a 3D scene to the viewer. Scene description extensions can be designed with a goal of decoupling the presentation engine 506 from the MAF 508. The presentation engine 506 and MAF 508 can communicate through the MAF API 502, which allows the presentation engine 506 to request media data required for the rendering of a scene. The MAF 508 can retrieve the requested media and make the media available in a timely manner and in a format that can be immediately processed by the presentation engine 506. For instance, a requested media asset may be compressed and residing in the network, so the MAF 508 can retrieve and decode the asset and pass the resulting media data to the presentation engine 506 for rendering. The media data is passed in form of buffers 512 from the MAF 508 to the presentation engine 506. The requests for media data are passed through the MAF API 502 from the presentation engine 506 to the MAF 508.

The format of the buffers 512 can be provided by the scene description document 514 and can be passed to the MAF 508 through the MAF API 502. Pipelines 516 can perform necessary transformations to match a buffer format and layout declared in the scene description document 514 for a specified buffer 512. The fetching of a scene description document 514 and scene description updates can be triggered by the MAF 508.

The presentation engine 506 can receive and parse the scene description document 514 and the scene description updates. The presentation engine 506 can identify external media to be presented and can identify a required presentation time. The presentation engine 506 subsequently uses the MAF API 502 to request the media by provides the scene description information. The scene description information can include where the MAF 508 can find the requested media, what parts of the media and at what level of detail, when the requested media has to be made available, a format for the data and how the data is passed to the presentation engine 506, etc.

The MAF 508 can instantiate the media fetching and decoding pipeline 516 for the requested media at the appropriate time. The MAF 508 can ensure that the requested media is available at the appropriate time in the appropriate buffers 512 for access by the presentation engine 506. The MAF 508 can ensure that the media is decoded and reformatted to match the format expected by the presentation engine 506 as described by the scene description document 514.

The exchange of data (media and metadata) can be performed through buffers 512, including circular and static buffers. The buffer manager 510 can be controlled through the buffer API 504. Each buffer 512 can contain header information to describe the content and timing. The presentation engine 506 can provide the MAF 508 with information to select an appropriate source for the media (multiple medias could be specified) and the MAF 508 may select the source of the media based on preferences and capabilities. Capabilities may include, for example, decoding capabilities or supported formats. Preferences may include, for example, user settings.

The presentation engine 506 can provide the MAF 508 with information for each selected source accessing the media by using a media access protocol and setup the media pipeline 516 to provide the information in the correct buffer format.

The MAF 508 can query or obtain additional information from the presentation engine 506 in order to optimize the delivery of the media. For example, the required quality for each of the buffers, the exact timing information, etc. can be queried or obtained by the MAF 508.

The MAF 508 can setup and manage a pipeline 516 for each requested media or metadata. A pipeline 516 can take one or more media or metadata tracks as input and one or more buffers as outputs. The pipeline 516 can perform all the necessary processing, such as streaming, demultiplexing, decoding, decryption, and format conversion to match the expected buffer format. The final buffer 512 or set of buffers 512 can be used to exchange data with the presentation engine 506.

V3C content is composed of two types of components, V3C atlas and V3C components, where the V3C atlas is an entry point for decoding the V3C content. Therefore, the scene description 514 list all the components while distinguishing V3C atlas from V3C component. The scene description 514 also can indicate V3C components must not be selected for processing unless a V3C atlas they belong to is selected.

Previous versions of the MPEG_media extension do not allow for distinction of V3C components from the V3C atlas. If V3C components are listed in MPEG_media then, the V3C component are considered media items that are individually referenceable. A new extension is included in the MPEG_media extension specifically listing the components items that are not directly referenced and processed together with other media items The listed items are separately processed from media items that independently referenceable. The definitions for MPEG_media are described in Table 1 below.

TABLE 1
Definitions of top-level objects of MPEG_media

| Name | Type | Default | Usage | Description |
|---|---|---|---|---|
| media | array | N/A | M | identical with |
| | | | | media property of |
| | | | | MPEG_media |
| | | | | extension |
| components | array | N/A | M | An array of items |
| | | | | that describe the |
| | | | | external media used |
| | | | | as a component |
| | | | | of an item in the |
| | | | | media array. |

In addition, previous MPEG_buffer_circular extensions can only reference items in the media array of MPEG_media. The MPEG_buffer_circular extension is extended to reference the items in the components array when MPEG_media_compound is used. The modifications for the MPEG_buffer_circular extension are shown below in TABLE 2.

TABLE 2
Amended definition of MPEG_buffer_circular.media

| | | | | |
|---|---|---|---|---|
| media | integer | N/A | M | Index of the media entry in the |
| | | | | MPEG_media extension, which |
| | | | | is used as the source for the |
| | | | | input data to the buffer. |
| | | | | If the MPEG_media_compound |
| | | | | extension is used, the items in |
| | | | | the components array is indexed |
| | | | | continuously after the items in the |
| | | | | media array without any gap. |
| | | | | For example, if there are 4 items |
| | | | | in the media array then the index |
| | | | | of the first item in the component |
| | | | | array becomes 4. |

The compound MPEG media extension, identified by MPEG_media_compound provides two arrays of the media items. The media array provides the list of media which can be directly referenced. The components array provides the list of media to be used as a component of one of the items in the media array. Definition of the media array is exactly the same as in the MPEG_media extension. The items in the components array can have one reference to the item in the media array. The definitions of items in the components array of the MPEG_media_compound extension are shown below in TABLE 3.

TABLE 3
Definitions of items in the components array of
MPEG_media_compound

| Name | Type | Default | Usage | Description |
|---|---|---|---|---|
| reference | integer | N/A | M | Index of the media entry |
| | | | | which the current item |
| media | | | | is used as a component of |
| alternatives | array | N/A | M | identical with |
| | | | | MPEG_media.media.alternatives |

Processing of the MPEG_media_compound extension can be identical to the MPEG_media extension with the exception of processing items in components array. In general, items in the components array may be referenced by a circular buffer and processed synchronously with the items in the media array that is referenced by MPEG_media_compound extension.

The scene description 514 can contain only one reference to a V3C atlas before decoding and 3D reconstruction of volumetric frames are performed by the MAF 508, and volumetric frames are delivered to presentation engine 506 through a single buffer 512. When a scene description 514 contains the references to all external media resources comprising a V3C content, both V3C atlas and all V3C components, then MAF 508 can instantiate the media decoders for each external media resource and the buffers 512 for each media decoders. Each external media resource is individually decoded and individually delivered to presentation engine 506 through the buffers 512. The presentation engine 506 can reconstruct volumetric frames by a 3D reconstruction process.

As shown in FIG. 5B, V3C content stored in multiple tracks can also be processed using a multiplexer 518. For example, a geometry track 520, a texture track 522, an occupancy track 524, an atlas track 526, and static metadata 528 can be provided to the multiplexer 518 for transmission to the presentation engine 506 using a single buffer 512.

When a V3C content is stored in multiple tracks and compressed bitstreams are to be delivered to the presentation engine 506 for decompression, 3D reconstruction, and rendering, the samples from all tracks with same CTS are multiplexed into a single unit and delivered to presentation engine 506 through a single buffer 512.

As there will be only one buffer 512 delivering data from MAF 508B to the presentation engine 506, the scene description 514 can list only one external media resource. However, there can be an indication whether decoding and reconstruction must be done by MAF 508B. Therefore, the following property can be added to MPEG_media extensions, which is shown in TABLE 4.

TABLE 4
Added property for MPEG_media

| | | | | |
|---|---|---|---|---|
| decoding | boolean | True | O | Specifies whether decoding |
| | | | | is performed by MAF or not. |
| | | | | If this property is set to False |
| | | | | then compressed bitstream is |
| | | | | delivered to Presentation Engine |
| | | | | without decoding. |

Although FIGS. 5A and 5B illustrates example scene description reference architectures 500 and 501, various changes may be made to FIGS. 5A and 5B. For example, the scene description reference architectures 500 and 501 may be used in any other suitable media processing and is not limited to the specific embodiments described above.

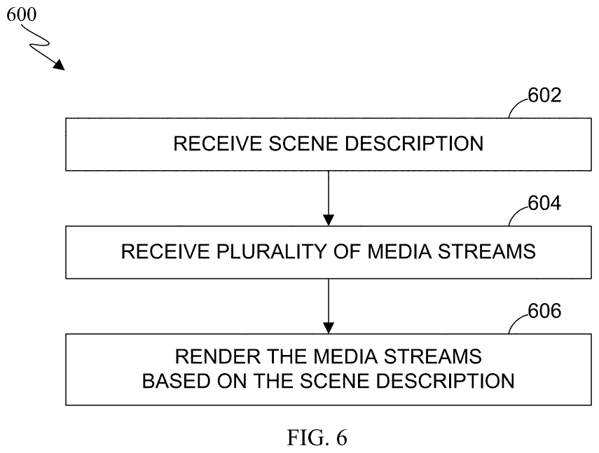

FIG. 6 illustrates an example method for support of V3C in an immersive scene description according to this disclosure. For ease of explanation, the method 600 of FIG. 6 is described as being performed using the presentation engine 506 of FIG. 6. However, the method 600 may be used with the electronic device 101 shown in FIG. 1 or any other suitable system and any other suitable electronic device.

As shown in FIG. 6, the presentation engine 506 receives a scene description at step 602. The scene description can be read from a storage or transferred from an external device. The scene description is used for rendering V3C content. The scene description can indicate a media stream for a V3C atlas and media streams for V3C components. The scene description can distinguish the plurality of media streams based on the V3C atlas and the V3C components. The scene description can indicate that the V3C components cannot be selected for processing until the V3C atlas is also selected for processing.

The presentation engine 506 receives a plurality of media streams at step 604. The media streams can include V3C content. The plurality of media stream including the V3C atlas and the V3C component can be synchronously received. In certain embodiments, the media streams are multiplexed and transmitting to the presentation engine using a single buffer.

The presentation engine 506 renders the media streams based on the scene description at step 606. The scene description can be used to render the V3C content in the media streams. The scene description can be a MPEG_media extension. The MPEG_media extension can include a media stream configured to indicate the V3C atlas and at least one component stream to indicate the V3C components. The at least one component stream can list the V3C components as an array.

The at least one component stream can be an MPEG_media_compound extension. The MPEG_media_compound extension can include a reference_media item including an index of the V3C content for the V3C components and an alternatives item indicating alternative for the V3C components.

Although FIG. 6 illustrates one example of a method 600 for support of V3C in an immersive scene description, various changes may be made to FIG. 6. For example, while shown as a series of steps, various steps in FIG. 6 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface including a buffer; and
a processor operably coupled to the communication interface, and configured to:
receive, via the communication interface, a scene description for visual volumetric video-based coding (V3C) content, wherein the scene description indicates a media stream for a V3C atlas and media streams for V3C components;
receive, via the communication interface, a plurality of media streams of the V3C content; and
render the plurality of media streams based on the scene description for the V3C content.

2. The apparatus of claim 1, wherein the scene description distinguishes the plurality of media streams based on the V3C atlas and the V3C components.

3. The apparatus of claim 2, wherein the scene description indicates that the V3C components cannot be selected for processing until the V3C atlas is also selected for processing.

4. The apparatus of claim 1, wherein the scene description is a MPEG_media extension.

5. The apparatus of claim 4, wherein the MPEG_media extension includes:
a media stream configured to indicate the V3C atlas; and
at least one component stream configured to indicate the V3C components.

6. The apparatus of claim 5, wherein the at least one component stream lists the V3C components as an array.

7. The apparatus of claim 5, wherein the at least one component stream is an MPEG_media_compound extension.

8. The apparatus of claim 7, wherein the MPEG_media_compound extension includes:
a reference_media item including an index of the V3C content for the V3C components; and
an alternatives item indicating alternatives for the V3C components.

9. The apparatus of claim 1, wherein the V3C atlas and the V3C components are synchronously received.

10. The apparatus of claim 1, wherein the media streams are multiplexed and received through a single buffer.

11. A method for support of visual volumetric video-based coding (V3C) in immersive scene descriptions, the method comprising:
receiving a scene description for V3C content, wherein the scene description indicates a media stream for a V3C atlas and media streams for V3C components;
receiving a plurality of media streams of the V3C content; and
rendering the plurality of media streams based on the scene description for the V3C content.

12. The method of claim 11, wherein the scene description distinguishes the plurality of media streams based on the V3C atlas and the V3C components.

13. The method of claim 12, wherein the scene description indicates that the V3C components cannot be selected for processing until the V3C atlas is also selected for processing.

14. The method of claim 11, wherein the scene description is a MPEG_media extension.

15. The method of claim 14, wherein the MPEG_media extension includes:
a media stream configured to indicate the V3C atlas; and
at least one component stream configured to indicate the V3C components.

16. The method of claim 15, wherein the at least one component stream lists the V3C components as an array.

17. The method of claim 15, wherein the at least one component stream is an MPEG_media_compound extension.

18. The method of claim 17, wherein the MPEG_media_compound extension includes:
a reference_media item including an index of the V3C content for the V3C components; and
an alternatives item indicating alternatives for the V3C components.

19. The method of claim 11, wherein the V3C atlas and the V3C components are synchronously received.

20. The method of claim 11, wherein the media streams are multiplexed and received through a single buffer.
